(19) United States
(12) Patent Application Publication
(10) Pub. No.: US 2013/0218444 A1
(43) Pub. Date: Aug. 22, 2013

(54) OPERATING METHOD FOR AN INTERNAL COMBUSTION ENGINE

(71) Applicant: DAIMLER AG, (US)

(72) Inventors: Torsten DIELER, Stuttgart (DE); Dirk Haase, Leutenbach (DE); Ruediger Herweg, Esslingen (DE)

(73) Assignee: DAIMLER AG, Stuttgart (DE)

(21) Appl. No.: 13/856,142

(22) Filed: Apr. 3, 2013

Related U.S. Application Data
(63) Continuation-in-part of application No. PCT/EP2011/005001, filed on Oct. 7, 2011.

(30) Foreign Application Priority Data
Oct. 7, 2010 (DE) 10 2010 047 799.0
Mar. 31, 2011 (DE) 10 2011 015 629.1

(51) Int. Cl. F02D 43/04

(52) U.S. Cl. CPC F02D 43/04
USPC 701/111

(57) ABSTRACT

In an operating method for a direct-injection gasoline internal combustion engine having a plurality of combustion chambers with at least partially low-NOₓ combustion (NAV) and a plurality of partial operating modes with at least one partial operating mode having controlled auto-ignition (RZV), a reduction in the reactivity of exhaust gas recirculated into the respective combustion chamber is achieved by means of an external exhaust gas recirculation using exhaust gas which has been conducted through an oxidation catalyst thereby improving the operating stability of the engine particularly in the auto-ignition partial operating mode.

This is a Continuation-in-Part application of pending international patent application PCT/EP2011/005001 filed Oct. 7, 2011 claiming the priorities of German patent applications 10 2010 047 799.0 filed Oct. 7, 2010 and 10 2011 015 629.1 filed Mar. 31, 2011.

### BACKGROUND OF THE INVENTION

The present invention resides in an operating method for an internal combustion engine, in particular for a reciprocating piston engine, for example a gasoline engine with direct fuel injection in a motor vehicle, with low-NOx generating combustion (NAV).

Downsizing can be used in the automotive engineering sector, in addition to other measures, in order to reduce CO2 emissions in this context downsizing means constructing, employing and operating small-displacement engines in such a way that they achieve equivalent or better rankings with respect to driving behavior when compared to their predecessor large-displacement engines. Downsizing allows fuel consumption to be reduced and thus CO₂ emissions to be lowered. In addition, engines with smaller displacements have lower absolute frictional losses.

Smaller displacement engines are, however, characterized by having lower torque, especially at low speeds, leading to the vehicle having a poorer dynamic response and thus reduced flexibility. Disadvantages associated with the downsizing of gasoline engines can be largely compensated for through appropriate operating modes.

From EP 1 543 228 B1 for example an operating mode is known wherein a lean fuel/exhaust gas/air mixture in the combustion chamber of the internal combustion engine is caused to auto-ignite. In order that compression ignition occurs at the desired time, fuel is introduced into the lean, homogeneous fuel/exhaust gas/air mixture in the combustion chamber at the appropriate compression shortly before being spark ignited, so that a richer fuel-air mixture is formed. Embedded in the lean, homogeneous fuel/exhaust gas/air mixture, this concentrated fuel-air mixture serves as the initiator for compression-ignited combustion in the combustion chamber.

DE 10 2006 041 467 A1 discloses for an operating mode for a gasoline engine having homogeneous compression-ignited combustion. If the homogeneous fuel/exhaust gas/air mixture, said mixture being a lean mixture, is compressed, in contrast to the Otto-cycle operating mode, combustion does not spread in the combustion chamber as a flame front originating from the point of ignition, but instead at an appropriate compression level the homogeneous fuel/exhaust gas/air mixture ignites almost simultaneously at several points in the respective combustion chamber so that in this case controlled auto-ignition sets in. Controlled auto-ignition (RZV) exhibits significantly lower nitrogen oxide emissions along with high efficiency in terms of fuel consumption compared to the spark-ignited Otto-cycle operating mode. This low-emission, efficient RZV operating mode with controlled auto-ignition can, however, only be used at a lower and possibly medium engine load/engine speed range, as knocking tendency increases with decreasing charge dilution, and thus the useful application of the RZV operating mode at higher engine load ranges is limited.

From the article “CARE—Catalytic Reformated Exhaust Gases in turbocharged DISI Engines” by Henrik Hoffmeyer, Emanuela Montefrancesco, Linda Beck, Jürgen Willand and Florian Ziebart in the magazine SAE Int. J. Fuels Lubr., Volume 2, Issue 1, an operating mode for a direct injection internal combustion engine with a plurality of combustion chambers is known that is implemented similar to a direct-injection Otto-cycle operating mode that is spark ignited. In order to achieve improved operational stability with the described operating mode, an oxidizing catalyst is arranged in an external exhaust gas recirculation line that removes any reactive components from the exhaust gas recirculated to the respective combustion chamber, such as hydrocarbons and/or carbon monoxide. In this way the amount of fuel being fed to the respective combustion chamber can be more precisely metered, since the exhaust gases being recirculated into the respective combustion chamber are virtually free of reactive components owing to the oxidation catalyst.

It is the object of the present invention to provide an improved, or at least an alternative operating mode, for a direct injection internal combustion engine, which is in particular characterized by reliable operating stability whilst simultaneously having low-NOₓ emissions in a large engine load range.

### SUMMARY OF THE INVENTION

in an operating method for a direct-injection gasoline internal combustion engine having a plurality of combustion chambers with at least partially low-NOₓ combustion (NAV) and a plurality of partial operating modes with at least one partial operating mode having controlled auto-ignition (RZV), a reduction in the reactivity of exhaust gas recirculated into the respective combustion chamber is achieved by means of an external exhaust gas recirculation using exhaust gas which has been conducted through an oxidation catalyst thereby improving the operating stability of the engine particularly in the auto-ignition partial operating mode.

Exhaust gas recirculation can be implemented during the RZV and NAV partial operating modes. Free radicals from previous operating cycles can be present in the recirculated exhaust gas. These have an influence on both the combustion process as well as the engine's susceptibility to knocking. The recirculation of exhaust gas through an oxidation catalyst affects the reactivity of the returned exhaust gas, since the free radicals are transformed in the catalytic converter. In this way the center of combustion can be influenced and operating stability can be improved.

An internal combustion engine, in particular a direct injection internal combustion engine having a plurality of combustion chambers, can be operated according to different operating modes or different partial operating modes. Hence there are a number of Otto-cycle partial operating modes possible. The stoichiometric Otto-cycle partial operating mode has a combustion air ratio or air/fuel ratio λ=1 and is spark ignited by an ignition device, whereby flame front combustion (FFV) sets in. The stoichiometric Otto-cycle partial operating mode can be applied throughout the entire engine load and/or engine speed range. It is preferentially implemented over other partial operating modes in the high engine load or engine speed range.

An Otto-cycle partial operating mode can be spark ignited even with excess air, and can thus be implemented with a combustion air ratio λ>1. This partial operating mode is also commonly referred to as the DES partial operating mode (Stratified Direct Injection), whereby a stratified, overall lean fuel/exhaust gas/air mixture is formed in the respective combustion chamber by multiple direct fuel injections. Due to its stratified composition, at least in an idealized system, each combustion chamber has two regions having different combustion air ratios λ. This stratification is typically generated through multiple fuel injections. First, a lean, homogeneous fuel/exhaust gas/air mixture may be introduced into the respective combustion chamber by one or more injections of fuel. Into this lean, homogeneous region, a fuel/air mixture, which is richer than that in the lean, homogeneous region, is then positioned in the area of the ignition device by a final injection of fuel that can also take the form of multiple injections. This method is commonly referred to as HOS (Homogenous Stratified Mode). The overall lean fuel/exhaust gas/air mixture in the combustion chamber can be ignited and reacted by flame front combustion (FFV) of the richer fuel/air mixture in the area of the ignition device. The DES and HOS partial operating modes are the preferred choice for the lower engine load and/or engine speed range.

The DES and HOS partial operating modes can also be compression ignited, but are then usually no longer referred to as DES or HOS partial operating modes.

At lower engine load and/or engine speed ranges, the RZV (self-ignition combustion) partial operating mode can likewise be implemented, whereby a lean, homogeneous fuel/exhaust gas/air mixture in the respective combustion chamber is triggered by controlled auto-ignition and therefore compression ignited. In contrast to an Otto-cycle partial operating mode, whereby a flame front combustion (FFV) occurs by spark ignition, with the RZV partial operating mode, the fuel/exhaust gas/air mixture in the respective combustion chamber ignites in multiple regions of the respective combustion chamber almost simultaneously so that controlled auto-ignition occurs. The RZV partial operating mode features significantly lower NOx emissions compared to the Otto-cycle partial operating mode, while at the same time being characterized by lower fuel consumption.

The NAV partial operating mode, which is the subject matter of the invention, can be thought of as being a combination of a spark-ignited, Otto-cycle partial operating mode and a RZV partial operating mode. Thus, for the NAV partial operating mode there is a homogeneous, lean fuel/exhaust gas/air mixture that is spark ignited by means of an ignition device. During the NAV partial operating mode, following an initial flame front combustion (FFV), the combustion of the homogeneous fuel/exhaust gas/air mixture transitions to a controlled auto-ignition (RZV). As a result, the NAV partial operating mode exhibits lower fuel consumption and reduced NOx emissions when compared to the Otto-cycle partial operating mode due to the controlled auto-ignition (RZV).

in contrast to the RZV partial operating mode, during the NAV partial operating mode combustion is spark ignited by an ignition device. For this reason, amongst others, operating stability of the mixture ignition and/or combustion is significantly improved, especially at the higher end of the engine load or engine speed range. Thus the homogeneous, lean fuel/exhaust gas/air mixture starts to combust with a kind of an Otto-cycle flame front combustion (FFV) that then transitions into a controlled auto-ignition (RZV). In this way the NAV partial operating mode combines the advantages of controlled auto-ignition (RZV) with the spark-ignited, operationally stable ignition of the fuel/exhaust gas/air mixture. This NAV partial operating mode, which is the subject matter of the invention, can be realized by supplying an appropriate fuel/exhaust gas/air mixture to each combustion chamber, as well as by spark igniting at the correct time by means of an ignition device.

The NAV partial operating mode is characterized by a low pressure gradient and a reduced knocking tendency. As a result, the NAV partial operating mode makes controlled auto-ignition (RZV) feasible at a higher engine load range at which the pure RZV partial operating mode is no longer operationally stable enough due to the increasing pressure gradient and irregular combustion conditions, and in particular, because of the increased knocking tendency.

A comparison of the partial operating modes leads to the following conclusion:

| Partial operating | Fuel | NOₓ | | Engine |
|---|---|---|---|---|
| modes | consumption | emissions | Application | smoothness |
| Otto-cycle | +/− | +/− | +++ | +/− |
| λ = 1 | | | | |
| DES | +++ | −− | + | +/− |
| RZV | ++ | +++ | + | +/− |
| NAV | ++ | ++ | ++ | ++ |

(− [symbol] deterioration, + [symbol] improvement, ++ [symbol] much improvement, +++ [symbol] very much improvent)

As a result, partial operating modes with controlled auto-ignition (RZV) exhibit b lower fuel consumption and reduced NOx emission values when compared with stoichiometric Otto-cycle combustion systems. Moreover, through the NAV partial operating mode, the operating range can be extended to include the efficient controlled auto-ignition mode. Engine smoothness with the NAV combustion process is also improved when compared to the partial operating modes with compression ignition.

A preferred embodiment of such a partial operating mode having at least partially controlled auto-ignition (RZV) is an RZV partial operating mode with substantially pure controlled auto-ignition. Here, substantially pure controlled auto-ignition (RZV) is understood to be ideally an RZV partial operating mode where exclusively controlled auto-ignition takes place. A certain percentage of another type of combustion can nevertheless take place as a result of disturbances, such an eventuality being encompassed by the formulation “substantially pure controlled auto-ignition (RZV)”. The main reason for this formulation is that the RZV partial operating mode involves substantially pure controlled auto-ignition (RZV), whereby disruptions of the partial operating mode can result in other combustion processes occurring that do not, however, predominate the pure controlled auto-ignition (RZV) or are a significant part of the partial operating mode.

The RZV partial operating mode is preferably implemented at an engine speed of between 5% and 70% of the internal combustion engine's maximum speed or an engine load of between 2% and 30% of the internal combustion engine's maximum load.

Another partial operating mode, for which a reduction in the reactivity of the exhaust gas recirculated into the respective combustion chamber is advantageous, at least with respect to the operational stability of the respective partial operating mode, is the NAV partial operating mode, wherein at the point of ignition (ZZP) a largely homogeneous, lean fuel/exhaust gas/air mixture with a combustion air ratio of λ≧1 in the respective combustion chamber is spark ignited by an ignition device, wherein flame front combustion (FFV) initiated by the ignition device transitions to controlled auto-ignition (RZV). A reduction in reactivity of exhaust gas recirculated into the respective combustion chamber is advantageous not only because in this case the NAV partial operating mode has a phase in which a controlled auto-ignition (RZV) takes place, but also with respect to the ignition behavior. The knocking tendency of the engine is in this way reduced.

The NAV partial operating mode is preferably implemented at an engine speed of between 5% and 70% of the internal combustion engine's maximum speed and/or at an engine load of between 10% and 70% of the internal combustion engine's maximum load.

A lean fuel/exhaust gas/air mixture is a fuel/exhaust gas/air mixture that has a combustion air ratio of λ>1 and thus an excess of air, whereas a rich fuel/exhaust gas/air mixture has a combustion air ratio of λ<1. A stoichiometric ratio is λ=1.

The combustion air ratio is a dimensionless physical quantity that is used to describe the composition of a fuel/exhaust gas/air mixture. The combustion air ratio λ is calculated as a quotient of the actual air mass available for combustion and the minimum stoichiometric air mass required for a complete combustion of the available fuel. Accordingly, if λ=1, one talks of a stoichiometric combustion air ratio or fuel/exhaust gas/air mixture, and when λ>1 of a lean air combustion ratio or fuel/exhaust gas/air mixture. Furthermore, if λ=1 or λ<1, one talks of a rich combustion air ratio or fuel/exhaust gas/air mixture.

In a preferred embodiment, there is for the NAV partial operating mode a combustion air ratio λ at the ignition point (ZZP) between 1 and 2.

Furthermore, the composition of the fuel/exhaust gas/air mixture can be specified by the charge dilution. Regardless of whether there is a lean, rich or stoichiometric fuel/exhaust gas/air mixture, the charge dilution dictates how much fuel in relation to the other components of the fuel/exhaust gas/air mixture was introduced into the combustion chamber. The charge dilution is the ratio of the mass of fuel to the total mass of the fuel/exhaust gas/air mixture that is present in the respective combustion chamber.

In a preferred embodiment of the NAV partial operating mode, the ideal charge dilution is set to between 0.03 and 0.05.

Because ignition timing plays a crucial role in the NAV partial operating mode, in a preferred embodiment the ignition point is set to occur at a crank angle (CA) of between −45° and −10°.

The crank angle (CA) is the position in degrees of the crankshaft in relation to the movement of the piston in the cylinder or combustion chamber. In the case of a four-stroke cycle, where an intake stroke is followed by a compression stroke, then an expansion stroke and subsequently an exhaust stroke, the top dead center (TDC) position of the retracted piston in the respective combustion chamber or cylinder between the compression stroke and the expansion stroke is usually assigned a crank angle (CA) of 0″. Starting from the top dead center position at 0° CA, the crank angle increases towards the expansion stroke and exhaust stroke and decreases towards the compression stroke and intake stroke. Using the described gradation system, the intake stroke occurs between −360° CA and −180 CA, the compression stroke between −180° CA and 0° CA, the expansion stroke between 0° CA and 180° CA and the exhaust stroke between 180° CA and 360° CA.

When a largely homogeneous, lean fuel/exhaust gas/air mixture is referred to, this is understood to be a homogeneous, lean fuel/exhaust gas/air mixture that is essentially uniformly distributed in the respective combustion chamber. In an ideal situation there is a completely homogeneous distribution. In a realistic scenario, however, small inhomogeneities can be present, but they have no significant impact on the respective partial operating mode. This type of homogenous, lean fuel/exhaust gas/air mixture can be produced by single or multi-point fuel injection. In a preferred embodiment the injections or multi-point injections of fuel are performed dependent on load and/or engine speed.

In addition, an internal exhaust gas recirculation can be effected as part of the NAV partial operating mode in order to preheat the fuel/exhaust gas/air mixture in the respective combustion chamber. This exhaust gas recirculation can be implemented as exhaust gas re-induction or exhaust gas retention. With exhaust gas re-induction, exhaust gas is fed into the respective combustion chamber through expulsion of the exhaust gas into the air intake and/or into the exhaust section with subsequent re-induction. As an alternative to, or in addition to exhaust gas re-induction, internal exhaust gas recirculation through the retention of exhaust gas can be implemented, wherein a portion of the exhaust gas is retained in the respective combustion chamber. In order to cool the fuel/exhaust gas/air mixture, it is possible to implement external exhaust gas recirculation whereby the externally recirculated exhaust gas can be additionally cooled and undergoes a reactivity reduction with respect to its reactive components.

The reactivity reduction of exhaust gas recirculated into the respective combustion chamber can be performed by oxidizing the uncombusted hydrocarbons and/or carbon monoxide present in the exhaust gas.

In a preferred embodiment such a reactivity reduction can also be undertaken by at least partial recirculation of exhaust gas from the exhaust system downstream of an oxidization catalyst. Since an oxidation catalyst is generally present in the exhaust system, in this case it makes sense to extract the exhaust gas in the flow direction down-stream of the oxidation catalyst and recirculate this exhaust gas, which has had its level of reactive components reduced, into the respective combustion chamber of the internal combustion engine. In this case it is also advantageous to anticipate a higher degree of cooling of the exhaust gas recirculated into the respective combustion chamber due to the greater distance the exhaust gas has to travel.

In a particularly preferred embodiment, reactivity reduction of the exhaust gas recirculated into the respective combustion chamber is performed by way of an oxidation catalyst arranged in an exhaust gas recirculation line. The oxidation catalyst is advantageously installed before an exhaust gas recirculation cooler that may be present in the respective exhaust gas recirculation line, as in this scenario the exhaust gas can ensure that the oxidation catalyst is kept at operating temperature.

The NAV partial operating mode can be implemented in combination with, and/or in addition to, a spark ignited, stratified DES partial operating mode.

In this case a preferred embodiment allows the ignition point (ZZP) and/or the center of the combustion to be set at a crank angle that corresponds to the crank angle at the ignition point (ZZP) and/or the combustion center of a spark ignited, stratified DES partial operating mode.

In this case a preferred embodiment involves the NAV partial operating mode being implemented at an engine speed range and/or engine load range at which a spark ignited, stratified DES partial operating mode is also possible.

In a particularly preferred embodiment, the NAV partial operating mode is implemented in combination with, and/or in addition to, a RZV partial operating mode with pure controlled auto-ignition (RZV), and operation is switched between the two partial operating modes if the alternate partial operating mode has a lower operating stability.

the invention also relates to an internal combustion engine that is operated according to such a method with at least partially controlled auto-ignition. In an advantageous embodiment of such an internal combustion engine a separate oxidation catalyst is disposed in an exhaust gas recirculation line, in particular arranged upstream of an exhaust gas recirculation cooler in the direction of flow of the exhaust gas.

Further important features and advantages of the invention are addressed in the sub-claims, the diagrams and the descriptions based on the diagrams.

It is understood that the features that are mentioned above and those still to be described in the following can be used not only in the combination specified in each case, but also in other combinations or individually, without exceeding the scope of the present invention.

The invention will become more readily apparent from the following description of exemplary embodiments of the invention which are illustrated in the figures and explained in greater detail in the description below with reference to the accompanying drawings.

### BRIEF DESCRIPTION OF THE DRAWINGS

It is shown in:

FIG. 1: a graphical representation of a combustion curve of the NAV operating mode,

FIG. 2: a comparison of valve lift heights of an RZV, NAV, and DES operating mode,

FIG. 3: a graphical representation of an engine characteristics map of the RZV and NAV operating modes,

FIG. 4: Setting conditions of the RZV and NAV operating mode, and

FIG. 5: an internal combustion engine with an oxidation catalyst arranged in an extern exhaust gas recirculation line.

### DESCRIPTION OF PARTICULAR EMBODIMENTS

FIG. 1 shows a combustion curve diagram 1 of a NAV partial operating mode, where the crank angle CA is plotted along the X-axis 2 in degrees while a combustion process BV in Joules is plotted on the Y-axis 3. The combustion development of the NAV partial operating mode is represented by a curve 4. A fuel/exhaust gas/air mixture introduced into the respective combustion chamber is spark ignited at an ignition point 5 and at a crank angle of −30°+/−5° CA. Up to a boundary line 6 the fuel/exhaust gas/air mixture introduced into the respective combustion chamber burns with a Otto-cycle flame front combustion (FFV). After the boundary line 6, the fuel/exhaust gas/air mixture, which has become further heated and subjected to increased pressure by the flame front combustion (FFV), begins to transition to a controlled auto-ignition (RZV). A sufficiently high pressure and temperature required for compression ignition are built up by the advancing flame front combustion (FFV). In this way the NAV partial operating mode can be divided into a phase I having homogeneous flame front combustion (FFV) and a phase II having controlled auto-ignition (RZV), whereby both phases I, II are indicated separated by the boundary line 6.

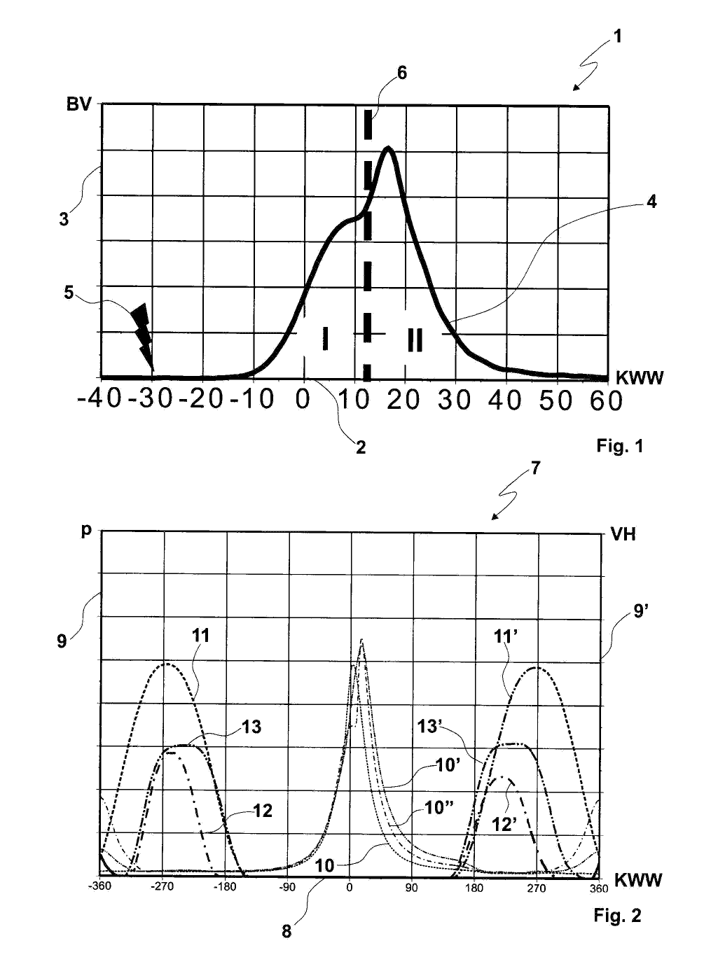

FIG. 2 shows a cylinder pressure/valve lift diagram 7, where the crank angle CA is plotted along the X-axis 8 in degrees while the cylinder pressure P in bar (left) and the valve lift VH in millimeters (right) is plotted up the Y-axis 9, 9′. The curves 10, 10′, 10″ reference the cylinder pressure curves of the DES, RZV and NAV partial operating modes respectively. The cylinder pressure gradation of the left Y-axis 9 applies to these curves.

Furthermore, the DES valve lift curves 11, 11′ the RZV valve lift curves 12, 12′ and the NAV valve lift curves 13, 13′ are plotted on the cylinder pressure/valve lift diagram 7. The valve lift gradation of the right Y-axis 9′ applies to these curves. On comparing the valve lift curves 11, 11′, 12, 12′, 13, 13′ one notices that the NAV valve lift curves 13, 13′ are considerably smaller than the DES valve lift curves 11, 11′. The DES valve lift curves 11, 11′ also span a larger range of crank angles than the NAV valve lift curves 13, 13′. As a result, exhaust gas retention or an internal exhaust gas recirculation is hardly possible with this type of DES valve lift curve 11, 11′. In contrast to this, NAV valve lift curves such as 13, 13′ allow an internal exhaust gas recirculation and/or an exhaust gas retention to be implemented.

If one now compares the RZV valve lift curves 12, 12′ and the NAV valve lift curves 13, 13′, one finds that the NAV valve lift curves 13, 13′ exhibit a slightly greater valve lift and moreover, they span a wider range of crank angles than the RZV valve lift curves 12, 12′. Consequently, such RZV valve lift curves 12, 12′ are characterized by a larger ex haust retention or internal exhaust gas recirculation, and allow as a result higher temperatures to be set in the combustion chamber. Due to the small amount of lift and short opening times, however, the air flow is greatly restricted. As a result, such RZV valve lift curves 12, 12′ are of only limited use for a high engine load range. This is improved with the illustrated NAV valve lift curves 13, 13′, since on the one hand higher valve lifts can be set, and on the other the valve remains open through a wider range of crank angles. Thus using such NAV valve lift curves as 13, 13′ allows a lower temperature in the particular combustion chamber to be set, and the intake air volume is greater than with the RZV valve lift curves 12. 12′ illustrated in FIG. 2.

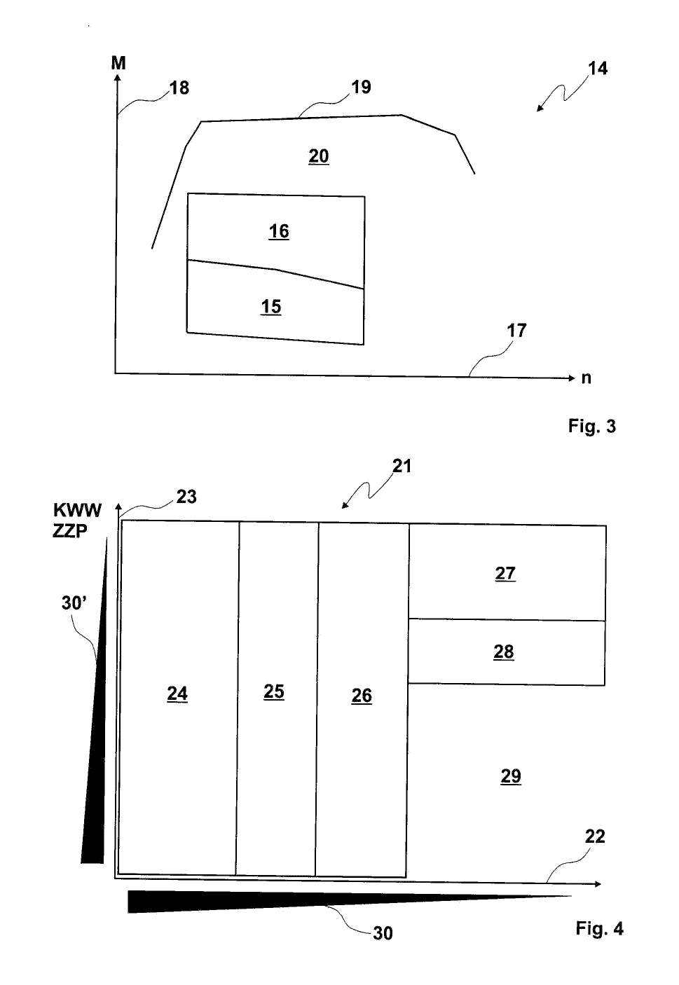

FIG. 3 shows an engine load/engine speed diagram 14, in which an engine characteristics map 15 for the RZV partial operating mode and an engine characteristics map 16 for the NAV partial operating mode are plotted. In the engine load/engine speed diagram 14, the engine speed n is plotted along the X-axis 17 while the engine load M is plotted up the Y-axis 18. A boundary curve 19 delimits the engine load and engine speed range within which the internal combustion engine can be operated. In the engine load/engine speed range 20, which is not encompassed by the engine characteristics map 15 of the RZV partial operating mode or by the engine characteristics map 16 of the NAV partial operating mode, an Otto-cycle partial operating mode can be implemented.

A setting conditions diagram 21 shown in FIG. 4 schematically illustrates setting conditions for the RZV partial operating mode and for the NAV partial operating mode. The charge dilution is plotted along an X-axis 22, that decreases in the direction of the X-axis 22 as illustrated by a tapered bar 30. Correspondingly, the engine load increases along the X-axis 22. The crank angle (CA) at the ignition point (ZZP) is plotted up a Y-axis 23, said crank angle likewise decreasing in the direction of Y-axis 23 as illustrated by a tapered bar 30′. The operating ranges 24, 25, 26, 27, 28, 29 are mapped in the settings condition diagram 21. The operating range 24 indicates a possible operating range for the RZV partial operating mode. In this very high charge dilution range it is not possible to spark ignite the correspondingly dilute fuel/exhaust gas/air mixture with an ignition device. The RZV partial operating mode can be advantageously implemented in said operating range 24. With decreasing charge dilution, both the RZV partial operating mode as well as the NAV partial operating mode can be advantageously implemented in operating range 25. By using the NAV partial operating mode, the center of combustion can be shifted to occur at an earlier crank angle by means of the ignition timing.

If one further lowers the charge dilution, one enters the operating range 26. While it is possible to implement the RZV partial operating mode in the operating range 26, in this charge dilution range, the RZV partial operating mode exhibits an increased knocking tendency and is characterized by a correspondingly large increase in pressure. Thus the RZV partial operating mode in this charge dilution range suffers from increased operating instability that can, by way of example, be mitigated through external exhaust gas recirculation. This operating range 26 can be bypassed by the NAV partial operating mode, whereby the center of combustion can in this case likewise be shifted to occur at a lower crank angle by the appropriate choice of ignition timing (ZZP).

The NAV partial operating mode is preferentially implemented in the operating range 27. An Otto-cycle partial operating mode can be implemented in the operating range 28. It is usually not possible to implement the RZV, NAV or DES partial operating modes in the operating range 29.

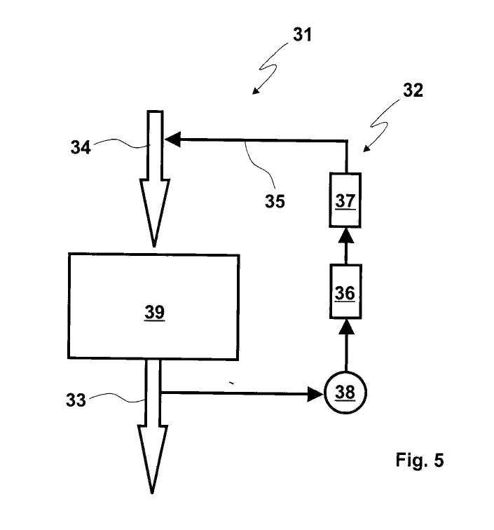

FIG. 5 shows an internal combustion engine 31 with an external exhaust gas recirculation 32. In order to reduce the reactivity of the exhaust gas, said exhaust gas having been recirculated from an exhaust flow 33 to an inlet flow 34 via an exhaust gas recirculation line 35, an oxidation catalyst 36 is arranged in the exhaust gas recirculation line 35. In a preferred embodiment, the oxidation catalyst 36 is arranged upstream in the direction of flow of the exhaust gas of an exhaust gas recirculation cooler 37. In a likewise preferred embodiment, the oxidation catalyst 36 is arranged downstream in the direction of flow of the exhaust gas of an exhaust gas recirculation valve 38, which may be present in the exhaust gas recirculation line 35 for the purpose of controlling the exhaust gas return rate.

To further improve operation of the internal combustion engine 31, the compression ratio of the internal combustion engine 31 must be advantageously calculated. In particular, the NAV partial operating mode is implemented with a compression ratio ε of between 10 and 13.

The compression ratio ε is the quotient of the compression volume of the combustion chamber when the piston is at its top dead center position and the sum of the compression volume and the stroke volume of the combustion chamber when the piston is at its bottom dead center position.

When switching from the RZV partial operating mode to the NAV partial operating mode, the compression ratio ε is lowered. As a result of the lower compression ratio ε, the knocking tendency is significantly reduced, and an earlier center of combustion, as well as a resultant increase in operational stability for the NAV partial operating mode, is effected.

When switching from the NAV partial operating mode to the RZV partial operating mode, the compression ratio ε is raised.

What is claimed is:

1. An operating method for a direct-injection, internal combustion engine with exhaust gas recirculation, whereby a controlled auto ignition (RZV) partial operating mode is implemented in a region of an engine characteristics map covering at least one of low to medium speed and low to medium load operation of the engine, and wherein said RZV partial operating mode is working with a lean fuel/exhaust gas/air mixture which is ignited by compression ignition and combusts by controlled auto-ignition (RZV), the region of the engine characteristics map with compression ignition being bordered at the higher load range by another region of the engine characteristics map in which low NOₓ combustion (NAV) is performed, said method comprising the steps of spark igniting, by means of an ignition device, at an ignition point (ZZP) a homogeneous lean fuel/exhaust gas/air mixture with a combustion air ratio λ≧1 in a combustion chamber of the internal combustion engine thereby generating a flame front combustion (FFV) initiating a transition to control auto-ignition (RZV) wherein, in at least one partial operating mode with controlled auto-ignition (RZV), a reactivity reducting exhaust gas derived from an external exhaust gas duct is recirculated into the respective combustion chamber.

2. The operating method according to claim 1, wherein an RZV partial operating mode having substantially pure controlled auto-ignition (RZV) is implemented as a partial operating mode with at least partial controlled auto-ignition (RZV).

3. The operating method according to claim 2, wherein the RZV partial operating mode is implemented at at least one of an engine speed of between 5% and 70% of the internal combustion engine's maximum engine speed and at an engine load of between 2% and 30% of the internal combustion engine's maximum engine load.

4. The operating method according to claim 1, wherein a NAV partial operating mode is implemented as a partial operating mode having at least partially controlled auto-ignition (RZV), wherein at the point of ignition (ZZP) a largely homogeneous, lean fuel/exhaust gas/air mixture with a combustion air ratio of in the respective combustion chamber is spark ignited by an ignition device, and wherein the flame front combustion (FFV) initiated by the ignition device transitions to controlled auto-ignition (RZV).

5. The operating method according to claim 4, wherein the NAV partial operating mode is implemented at an engine speed of between 5% and 70% of the internal combustion engine's maximum engine speed and/or at an engine load of between 10% and 70% of the internal combustion engine's maximum engine load.

6. The operating method according to claim 1, wherein a reduction in the reactivity of the uncombusted hydrocarbons and carbon monoxide present in the exhaust gas is performed by way of oxidation.

7. The operating method according to claim 1, wherein the reactivity reduction is performed by at least partial recirculation of exhaust gas derived from the exhaust system downstream of an exhaust gas of an oxidation catalyst.

8. The operating method according to claim 1, wherein the reactivity reduction is performed by a separate oxidation catalyst arranged in a exhaust gas recirculation line.

9. The operating method according to claim 1, wherein when switching from the RZV partial operating mode to the NAV partial operating mode, a compression ratio ε is lowered, and when switching from the NAV partial operating mode to the RZV partial operating mode, the compression ratio ε is raised.

10. An internal combustion engine operable according to the operating method of claim 1.

11. An internal combustion engine according to claim 10, wherein a separate oxidation catalyst (36) is arranged in an exhaust gas recirculation line (35) upstream of an exhaust gas recirculation cooler (37) arranged in the exhaust gas recirculation line (36).
